(19) United States
(12) Patent Application Publication
(10) Pub. No.: US 2004/0247725 A1
(43) Pub. Date: Dec. 9, 2004

(54) Form tool for producing particle foam moulded parts

(76) Inventors: Eberhard Lang, Heilbronn (DE); Rudiger Jahnke, Gotha (DE); Maik Ziegler, Grafenhain (DE); Jurgen Bruning, Werther (DE); Kai Wacker, Leonberg (DE); Knut Hofmann, Bretten (DE)

Correspondence Address: Norman P Soloway, Hayes Soloway, 130 West Cushing Street, Tucson, AZ, 85701, US

(21) Appl. No.: 10/493,934

(22) PCT Filed: Nov. 20, 2002
(86) PCT No.: PCT/EP02/13014

(30) Foreign Application Priority Data
Nov. 20, 2001 (DE) 101 56 590.9

(51) Int. Cl. B29C 33/00

(52) U.S. Cl. 425/183; 425/193; 425/406

(57) ABSTRACT

The invention relates to a form tool for producing particle foam molded parts having at least one tool part consisting of a finite number of layers which are parallel to each other, at least in segments, in which the individual layers have contours such that a stack formed by the totality of all layers defines at least one part of a form cavity which can be filled with expandable beads of a thermoplastic material, and having means for supplying and discharging gaseous and liquid heat transfer media. In order to obtain a faster production of particle foam molded parts with improved surface quality and uniform welding of the foam particles and in the same time a reduction of the energy quantity necessary for the production of the molded parts, it is proposed that the layers are arranged, at least in their regions adjacent to the form cavity, at a defined distance to each other to form channels which are outwardly sealed but are open inside the tool part for the penetration of the gaseous and liquid heat transfer media.

The invention relates to a form tool for producing particle foam molded parts, having at least one tool part consisting of a finite number of layers which are parallel to each other, at least in segments, in which the individual layers have contours such that a stack formed by the totality of all layers defines at least one part of a form cavity which can be filled with expandable beads of a thermoplastic material, and having means for supplying and discharging gaseous and liquid heat transfer media to or from the layers circumscribing the form cavity.

Particle foam materials are thermoplastic foam materials which are welded together to blocks or to molded parts from pre-expanded, still further expandable small foam particles. The shaping and the welding are carried out in the steam molding process in form tools designed especially therefor.

The known form tools are fabricated of milled aluminum plates or of cast aluminum which afterwards are provided with borings in order to set in nozzles through which it is possible to blow superheated steam in the form cavity under high pressure.

Beads made of expandable polystyrene (EPS), polyethylene (EPE) or polypropylene (EPP) are blown in the form cavity of the tool and condensed. After that, both form tool halves which are located in a steam chamber as well as the vented particle bed therein are penetrated by alternatively both steam chamber halves being acted with superheated steam. Due to this, the particles at least on the surface are heated to a temperature which leads to the welding or the caking of the particles on the surface (thermal and integral joint). Afterwards, the side of the form tool which is away to the particle foam is acted upon with cooling water or with another cooling medium, whereby the tool is not only cooled down but the produced particle foam molded part is also stabilized.

Individual aspects of the manufacturing and the utilization of laminated form tools are known from the patent literature:

DE-A1-42 17 988 describes the production of forming tool prototypes from stacked thin layers, from which contours are cut out by laser beam or water jet, the totality of the contours shaping the forming surface of the tool to be produced.

U.S. Pat. No. 2,679,172 describes an external high pressure deep-drawing die whose female die is formed by contour-cut layers which are horizontally stacked in a seat. By means of exchange, insertion or removal of individual regions of this female die, it is possible to change quickly and simply the geometry of the form cavity and in this way of the work piece produced. DE-A1-44 09 556 describes a bending tool especially for the swaging of bent sheet metal components. This tool in the form of a bending punch and/or a female die is composed of a pack of individual lamellas which are coupled to form a pack and are arranged in sequence in direction of the bending axle of the tool, their faces being in contact.

U.S. Pat. No. 5,031,483 discloses the production of deep-drawing die molds fabricated of contour-cut thin layers which are arranged in parallel to the parting plane of the tool, the direct placing of cooling or tempering channels being provided. Besides this, the patent describes the possibility to mount spacing means between several selected layers in order to bring pressurized air or vacuum to the surface of the work piece. But this does not make it possible to introduce welding or cooling media over an area. The cooling is mainly carried out by heat conduction. The uniform venting of the form tool during the filling, which is important in the production of particle foam molded parts, is not provided.

Particle foam form tools which are produced in the form of two shells which have webs with nozzles by means of stereolithography are known from EP-A1-0 908 286. The shells are back-filled with a temperature-resistant resin in order to give the necessary stability to the tool.

Particle foam form tools made of silicone and mechanically stabilized to both sides of the tool half by similar pressure control are known form DE-A1-195 00 601.

According to DE-A1-33 30 826 and EP-A1-0 720 528 the optical disadvantages, which arise from impressions of nozzles on the surface of foam molded bodies can be avoided by using a tool surface which is finely porous at its face. For this, forms are used which consist completely or mainly of sintered metal.

WO 94/09973 proposes a thermal insulation of the molded part tool in order to reduce the energy consumption of the production of particle foam molded parts, particularly as in conventional processes the energy consumption for the welding of the foam particles is inferior to 1% of the energy to be produced for the manufacturing of molded parts. Longer cycle times but above all the lack of mechanical and thermal resistance of the insulating layers restrict this process to polystyrene foam particles which are processed at low temperatures and steam pressure.

The object of the invention is to develop and to improve a form tool for producing particle foam molded parts of the type mentioned at the beginning, such that a faster computer supported production of particle foam molded parts with a good surface quality and an uniform welding of the foam particles can be made possible and at the same time the necessary steam and energy quantity can be reduced considerably.

According to the invention, this object is achieved for a form tool of the type mentioned at the beginning by the fact that the layers are arranged, at least in their regions adjacent to the form cavity, at a defined distance to each other to form channels which are outwardly sealed but are open inside the tool part for the penetration of the gaseous and liquid heat transfer media.

The solution according to the invention of the mentioned object is achieved by a stacked arrangement which, due to defined distances of all individual layers to each other, causes an uniform supplying of the thermal active media for the welding of the foam particles or beads as well as for the cooling of the foam particles, of the molded body formed thereof and of the form tool but also serves to the fast venting of the tool during the filling. Preferably, superheated steam for heating and water for cooling are used as thermal active media. The laminated arrangement of the form tool according to the invention leads to a homogeneous supply of superheated steam and of cooling water over the faces and from all sides directly in the form cavity inside the tool and ensures in this way a fast heating and a fast cooling of the foam particles. In comparison to the previous usage of separate steam chambers, this leads not only to considerable constructive savings but also to a considerable reduction of the steam and energy consumption. Since the form tool according to the invention does not have any steam nozzles which form, at the same time, a part of the form cavity surface, the particle foam molded parts formed with the tool according to the invention can not show any disturbing impressions of steam nozzles on the surface. This leads to an optical improvement and to a homogeneous surface quality of the molded parts.

Preferably, the layers consist of a well heat-conducting metallic material and are produced in form of thin lamellas or sheet metals for example. It is particularly preferred that the layers consist of sheet steel, aluminum or an aluminum alloy.

Preferably, the layers are cut from the desired material by computer-aided means, such that right from the beginning the contours of the particle foam molded part to be produced are exactly determined, such that it is not necessary to subject the contours to a subsequent treatment. For cutting out the layers in metal working it is possible to use conventional cutting techniques, such as for example cutting by laser beam or by water jet. However, it is also possible to produce the layers by using a computer-aided process which is known for the production of prototypes, for example by using the “laminated object manufacturing (LOM)-process”.

In an advantageous embodiment of the form tool according to the invention the layers have openings which are divided by solid webs and are arranged, such that a plurality of chambers which intersperse the tool part are formed in a stack formed by the totality of all layers. The large volume of these chambers reduces advantageously the total mass of the tool, favors a faster and effective diffusion of the gaseous and liquid heat transfer media, by which superheated steam and cooling water are preferably meant, and leads to a considerably inferior loss of energy in comparison to the additional steam chambers necessary in the prior art which, according to the invention, can be left out because the cavities themselves, which are created by the openings of the layers, take over the function of a steam chamber and at the same time the function of a cooling water accumulator.

That is, a particular advantage of the form tool according to the invention is the fact that the contours of the form-cut layers depict the forming tool wall as well as steam chambers, media guide and support. Due to this, the tool mass is reduced, the energy consumption and in this way the operation expenses are diminished and the arrangement of the tool simplified.

Preferably, at least each second layer of a stack shows at least one prolongation which operates as heat exchange surface and projects in the openings or in the chambers. This results in a faster heat transport in both directions, and so to a faster heating when superheated steam or another hot gas is guided through the chambers, and to a faster cooling when water or another cooling medium flows through the chambers.

Preferably, the form tool according to the invention has only one supplying pipe and only one discharging pipe for the heat transfer media used as heating or cooling media because the general construction is suitable for the flow of both the gaseous and the liquid heat transfer media.

Preferably, the defined distances between the layers are formed by intermediate plates which are placed only at the external sides of the tool. As a result, a nearly completely closed wall is produced at the external sides of the tool while channels which are parallel inside and have a defined width remain open for the penetration of the media.

Alternatively, the distances can be formed by stampings, millings or etched recesses at one or both sides in the layers, the stampings being preferably designed as waves, channels, ribbings or knobs in the form of truncated cones or truncated pyramids. A regular diffusion of the stampings in form of knobs or waves is particularly preferred, such that a mutual fixation or a parallel centering of the layers can be managed, which is also possible with pins which are engaged with each other.

In order to avoid the escape of the media to the outside and a direct flow of the media through the parting plane between two form halves into the respective other tool half, the layers at the external sides of the tool are sealed to each other, namely preferably by material assembling such as welding, diffusion welding, bonding, screwing or soldering. The layers can be connected to other thin layers by soldering as well, the thin layers having a lower melting point than the layers themselves.

The sealing of the form tool according to the invention to the external region and to the parting plane can be carried out by placing liquid curable materials in the external spaces between the layers as well as by bonding, welding or soldering. Here, soldering material or sealing compound can already be applied to the individual layers and can get the desired sealing effect only after their stacking or assembling by heating. For this, silicones and resins filled with aluminum and other known sealants can be used as sealing compounds. Preferably, a complete metal envelope which outwardly pressure seals the channels between the layers can be arranged around the form tool.

In another preferred embodiment of the form tool according to the invention, several stacks of layers which are arranged in parallel and have different directions are connected to each other. The parallel layers can run at one or several angles which differ from the right angle to the parting plane. These embodiments of the invention are particularly suitable to make it possible to show undercuts in the particle foam molded parts that have to be produced and to reduce the step effect. As a result, individual stacks, packs or clusters of layers which are connected to each other can be arranged at anyone and different angles to each other and can form in their totality at least two tool parts which together constitute the form tool.

In other embodiments of the invention the front sides of the layers which circumscribe the form cavity can show a structured surface, particularly a stamped or etched surface. The so structured surface can show for example square or round, raised or recessed cross sections and in this way form a kind of “pin-cushion” which circumscribes the form cavity.

Surprisingly, it turned out that the surface structure of the front sides has a considerable influence on the friction noise behavior of the finished particle foam molded parts. The unpleasantly screeching noise which usually appears during a friction between two surfaces of molded parts made of particle foam, particularly of polystyrene particle foam (Styropor®), can be avoided surprisingly effectively by the described surface structure, the special type of the structure having to be found out empirically from case to case, which particularly depends on the type of the expandable polymer used. The cleanability of the surfaces of the produced particle foam molded parts can also be influenced specifically by different surface structure.

With respect to a tool holding fixture, the form tool according to the invention is preferably thermally disconnected in order to avoid unnecessary energy losses.

The invention is further described with reference to the drawings:

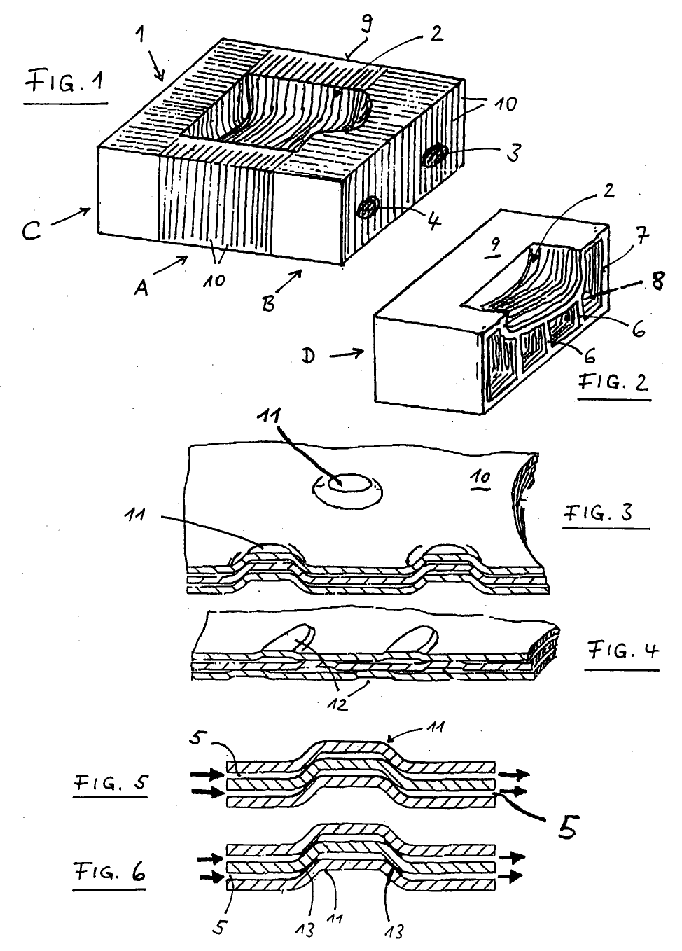

FIG. 1 is a perspective view of a tool part (form half) of an embodiment of a form tool according to the invention;

FIG. 2 is a cut view through another embodiment of a tool part of a form tool according to the invention;

FIG. 3 is a perspective partial view, partially in section, of a group of three layers fixed at a defined distance to each other by stampings;

FIG. 4 is a partial view (partially in section) of another group of layers which are mutually fixed by stampings;

FIG. 5 is a schematic sectional view of a group of mutually fixed layers; and

FIG. 6 is a schematic sectional view of a group of layers which are soldered to each other.

Usually, the form tool according to the invention consists of two tool parts 1 which are formed in a complementary way, the tool parts 1 consisting themselves of a finite number of layers 10 which are parallel to each other in segments. In the drawn embodiment, the layers 10 consist of aluminum sheets which are cut by computer-aided means. Three stacks A, B, C (FIG. 1) with different directions are formed from the layers 10, the individual layers inside the stack being arranged in parallel and the stacks being connected to each other to form the tool part 1. In the drawn embodiment, all parallel layers 10 are at a right angle to the tool parting plane 9.

The individual layers 10 have contours, such that the stacks A, B, C formed by the totality of the layers 10 define respectively a part of the form cavity 2 which can be filled with expandable foam pearls (beads) of a thermoplastic material, such as for example EPS, EPE or EPP in order to form appropriate particle foam molded parts thereof using the steam molding process.

The tool part 1 is provided with one single supplying pipe 3 and one single discharging pipe 4 for gaseous and liquid heat transfer media, particularly for superheated steam and cooling water. In the agreed utilization of the form tool according to the invention, first superheated steam for the welding of the beads and afterwards cooling water or another appropriate cooling medium for the cooling of the produced molded part and of the form are guided through the tool part 1 through the same pipe.

The layers 10 are arranged at a defined distance to each other to form channels 5 (FIGS. 3 to 6) which are outwardly sealed (FIG. 1) but are open inside the tool part 1 for the penetration of the gaseous and liquid media which operate as heat transfer media.

Due to this, it is obtained that the heating and cooling media are guided very quickly and via large effective faces directly to the form cavity 2, such that it is possible to transport energy faster and with relatively low energy losses in both directions, for the heating as well as for the cooling.

Another advantage of the form tool according to the invention is that the construction in segments with integrated supplying and discharging of the heating and cooling media reduces the total mass and at the same time the total energy demand of the tool.

In another preferred embodiment of the invention the layers 10 show openings 7 which are divided by solid webs 6 (FIG. 2), the openings being arranged such that several chambers 8 which intersperse the tool part 1 are formed in a stack D formed by the totality of all layers 10. This embodiment has cavities which ensure a sufficient volume for the fast diffusion of the active media (superheated steam and cooling water), lead to an elimination of the energetically inconvenient steam chambers necessary in the prior art and additionally reduce the total mass of the tool. In order to avoid the escape of the media to the outside and a direct flow through the parting plane 9 into the respective other tool half, the layers 10 at the external sides of the tool part 1 are pressure-sealed to each other, for example by welding, bonding or soldering.

The defined distances of the layers 10 to each other can be obtained in different ways. If for example metal sheets which are stamped at one side and have regular structures are used as layers 10, for example some with stampings designed as knob, pyramid or fish bone, the forming layers 10, considering the stamping pattern, can be cut such that the stampings 11 are arranged in register (FIG. 3) and in this way are secured positively against displacement.

But the stampings 12 (FIG. 4) can also be offset to each other, such that the individual layers 10 are in point contact or in line contact across the entire surface and, as a result, form a dimensionally stable arrangement as far as to the forming tool wall.

A defined distance between the individual layers 10 and in this way a defined and preferably constant width of the channels 5 between the layers 10 is preferably obtained by an integral three-dimensional and porous compound when the layers 10 which are provided with stampings 11 are stacked in register and are bonded, soldered or diffusion welded at the contact points of the stampings 11. Before the contours are stamped or cut out, layers of soldering material are applied to the sheet metals or to the layers 10 which fuse on after the assembling of the tool by heat treatment and create soldering connections 13 at the contact points by capillarity (FIG. 6).

The other way round, soldered stacks of layers 10 can so be separated again in the individual layers and, if necessary, can be exchanged for layers 10 having other contours such that it is possible to manufacture molded parts with another geometry.

The front sides of the layers 10 which circumscribe the form cavity 2 can show a structured surface (not shown in the drawings). The desired structure here can be etched or can already be placed in the edges of cut during the trimming of the layers 10. It is also possible to place soluble layers between the layers 10 before etching and to wash them out after the etching.

The particle foam molded parts which are manufactured with the form tool according to the invention and are preferably made of expandable polypropylene (EPP), but also of EPE and EPS, show a particularly uniform welding of the particles and a smooth surface without impressions of steam nozzles and with a low development of friction noise. The manufacturing of the molded parts is accelerated by the form tool and due to the low energy consumption, the costs are reduced.

1-20 (canceled)

21: A form tool for producing particle foam molded parts, having at least one tool part comprising a finite number of layers which are parallel to each other, at least in segments, in which the individual layers have contours such that a stack formed by the totality of all layers defines at least one part of a form cavity which can be filled with expandable beads of a thermoplastic material, and having conduits for supplying and discharging gaseous and liquid heat transfer media to or from the layers circumscribing the form cavity and being arranged, at least in their regions adjacent to said form cavity, at a defined distance from each other to form channels which are outwardly sealed but are open inside said tool part for the penetration of the gaseous and liquid heat transfer media, wherein the distances are formed by stampings, millings or etched recesses at one or both sides in the layers.

22: The form tool according to claim 21, wherein said layers comprise a heat-conducting metallic material.

23: The form tool according to claim 22, wherein said layers comprise sheet steel, aluminum or an aluminum alloy.

24: The form tool according to claim 21, wherein said layers define openings which are divided up by solid webs and arranged such that a plurality of chambers which intersperse the tool part are formed in a stack formed by the totality of all layers.

25: The form tool according to claim 24, wherein at least each second layer of said stack defines at least one prolongation which operates as heat exchange surface and projects in the openings or in the chambers.

26: The form tool according to claim 21, and comprising a single supply conduit and a single discharge conduit for the heat transfer media.

27: The form tool according to claim 21, wherein said stampings are designed as waves, channels, ribbings or knobs in the form of truncated cones or truncated pyramids.

28: The form tool according to claim 21, wherein said layers define stampings at one side and, considering the stamping pattern, are cut such that the stampings are arranged in register and in this way are secured positively against displacement.

29: The form tool according to claim 21, wherein said stampings are offset to each other such that the individual layers are in point contact or in line contact across the entire surface.

30: The form tool according to claim 21, wherein said layers are connected to each other by welding, diffusion welding, bonding, screwing or soldering.

31: The form tool according to claim 30, wherein said layers are connected to other thin layers by soldering, said thin layers having a lower melting point than said layers themselves.

32: The form tool according to claim 1, and comprising a plurality of stacks of layers which are arranged in parallel, with the stacks formed with different directions.

33: The form tool according to claim 1, wherein the parallel layers run at one or several angles which differ from the right angle to the parting plane of the tool.

34: The form tool according to claim 21, wherein the front sides of the layers which circumscribe the form cavity define a structured surface.

35: The form tool according to claim 34, wherein the surface of the front sides is stamped or etched.

36: The form tool according to claim 34, wherein the surface of the front sides defines square or round, raised or recessed cross sections.

37: The form tool according to claim 35, wherein the surface of the front sides defines square or round, raised or recessed cross sections.

38: The form tool according to claim 21, wherein said channels are outwardly pressure-sealed by a metal envelope.

39: The form tool according to claim 21, wherein said channels are outwardly pressure-sealed by a curable sealant, by bonding, welding or soldering of adjacent layers.

40: The form tool according to claim 21, wherein said form tool is thermally disconnected with respect to a tool holding fixture.
